(19) United States
(12) Patent Application Publication
(10) Pub. No.: US 2014/0189550 A1
(43) Pub. Date: Jul. 3, 2014

(54) METHODS AND DEVICES FOR ADJUSTING A GRAPHICAL USER INTERFACE

(71) Applicant: CROSS COMMERCE MEDIA, New York, NY (US)

(72) Inventors: Stephen Messer, New York, NY (US); Michael Martinov, Greenwich, CT (US); Heidi Messer, New York, NY (US); Mark Ritzmann, New York, NY (US); Russell William Martin, JR., New York, NY (US)

(73) Assignee: CROSS COMMERCE MEDIA, New York, NY (US)

(21) Appl. No.: 13/729,957

(22) Filed: Dec. 28, 2012

(51) Int. Cl. G06F 3/0481

(52) U.S. Cl. CPC G06F 3/0481
USPC 715/765

(57) ABSTRACT

Certain embodiments of this disclosure include methods and devices for adjusting a graphical user interface. According to one embodiment, a method is provided. The method may include obtaining external stimulus data including data associated with at least one user interface element of a plurality of user interface elements making up a graphical user interface (GUI); analyzing the external stimulus data to detect a presence of a GUI presentation adjustment condition; in response to detecting the presence of the GUI presentation adjustment condition, generating GUI presentation adjustment condition data including data describing the GUI presentation adjustment condition; and adjusting presentation of at least one of the plurality of user interface elements based on the GUI presentation adjustment condition data.

### FIELD

The instant disclosure relates generally to generating graphical user interfaces and, more specifically, to methods and devices for adjusting one or more graphical user interfaces based on external stimulus data associated with one or more user interface elements.

### BACKGROUND

A graphical user interface (GUI) is a type of user interface that allows users to interact with electronic devices using images rather than text commands. Users may interact with GUIs via conventional input/output devices, such as a mouse and display. GUIs are typically made up of several discrete elements, which are referred to herein as “user interface elements.” One common type of GUI is known as a desktop. A typical desktop may include one or more icons representing underlying applications (i.e., computer programs) that may be selected for execution via the GUI (e.g., by selecting the icon using a mouse, as known in the art). In the context of the instant disclosure, an icon would represent one example of a user interface element.

It is often desirable to adjust the presentation of a GUI in order to enhance the usability of the interface. Indeed, several techniques and systems currently exist directed to dynamically adjusting/altering GUIs by adjusting/altering the presentation of the discrete user interface elements making up the GUI. For example, certain existing techniques and systems teach adjusting/altering a GUI based upon the manner in which a user interacts with the discrete user interface elements making up the GUI. One such example is U.S. Patent Application Publication Number 2003/0090515 entitled “Simplified User Interface by Adaptation Based on Usage History” to Chang et al., which teaches monitoring input commands to the GUI and tracking usage statistics in order to determine whether to add or remove user interface elements from the GUI. Thus, these types of techniques and systems concentrate on how a user interacts with a GUI in order to determine how to adjust the layout of the GUI.

Other conventional techniques and systems directed to adjusting GUIs focus on the ambient environment in the proximity of a user interacting with a GUI in order to determine how and when to adjust the GUI. For example, U.S. Patent Application Publication Number 2009/0055739 entitled “Context Aware Adaptive User Interface” to Murillo et al. teaches monitoring ambient environmental conditions (e.g., lighting, noise, etc.) in the proximity of a user (i.e., in the proximity of the electronic device displaying the GUI that the user is interacting with) and adjusting/altering the layout of the GUI based upon those ambient environmental conditions.

However, these existing technologies are necessarily limited in their functionality because they base adaptation/adjustment determinations on user-centric data. Stated another way, conventional technologies narrowly focus how a user interacts with a GUI and/or the ambient environment affecting the user in deciding how and when to adjust/alter the GUI.

Accordingly, there is a need for a new technology aimed at addressing one or more of the drawbacks associated with conventional techniques for adapting and adjusting GUIs.

### SUMMARY

The instant disclosure describes methods and devices for adjusting a graphical user interface (GUI). To this end, in one example, a method for adjusting a GUI including a plurality of user interface elements is provided. The method includes obtaining external stimulus data. External stimulus data may include data associated with at least one user interface element of the plurality of user interface elements. The external stimulus data may be analyzed to detect a presence of a GUI presentation adjustment condition. In response to detecting the presence of a GUI presentation adjustment condition, GUI presentation adjustment data may be generated. The GUI presentation adjustment data may include data describing the GUI presentation adjustment condition. The presentation of at least one of the plurality of user interface elements may be adjusted based on the GUI presentation adjustment condition data.

In one example of the method, one or more of the plurality of user interface elements may include display data representing one or more applications. In this example, analyzing the external stimulus data to detect the presence of a GUI adjustment condition may include analyzing respective data streams associated with each of the one or more applications.

In another example of the method, adjusting the presentation of at least one of the plurality of user interface elements is further based on historical data and/or default GUI presentation data. Historical data may include data describing one or more previous user interactions with at least one of the plurality of user interface elements. Default GUI presentation data may include data describing a predefined presentation of the plurality of user interface elements. In yet another example, adjusting the presentation of at least one of the plurality of user interface elements includes performing one or more of the following: (i) adjusting an arrangement of the plurality of user interface elements within the GUI; (ii) adjusting a size of at least one of the plurality of user interface elements within the GUI; (iii) adjusting a color of at least one of the plurality of user interface elements within the GUI; (iv) adjusting an amount of the plurality of user interface elements within the GUI; and/or (v) adjusting the content of at least one of the plurality of user interface elements within the GUI.

In one example, the external stimulus data that is obtained and analyzed may include data that is independent of user behavior. In still another example, the external stimulus data may include data that is independent of an ambient user environment.

According to another embodiment of the instant disclosure, a computing device for adjusting a GUI including a plurality of user interface elements is provided. The computing device includes, at least, an external stimulus data analyzing module and a GUI adjusting module. The external stimulus data analyzing module is configured to obtain external stimulus data associated with at least one of the plurality of user interface elements. The external stimulus data analyzing module is also configured to analyze the external stimulus data to detect the presence of a GUI presentation adjustment condition. In response to detecting the presence of a GUI presentation adjustment condition, the external stimulus data analyzing module is further configured to generate GUI presentation adjustment condition data, which may include data describing the GUI presentation adjustment condition. The GUI adjusting module is operatively connected to the external stimulus data analyzing module and is configured to adjust the presentation of at least one of the plurality of user interface elements based on the GUI presentation adjustment condition data.

In one example of the computing device, one or more of the plurality of user interface elements may include display data representing one or more applications. In this example of the computing device, the external stimulus data analyzing module may be configured to detect the presence of the GUI presentation adjustment condition by analyzing respective data streams associated with each of the one or more applications.

In another example of the computing device, the GUI adjusting module may be further configured to (i) obtain historical use data and default GUI presentation data and (ii) adjust the presentation of at least one user interface element of the plurality of user interface elements based on the historical use data and/or default GUI presentation data. Again, historical use data may include data describing one or more previous user interactions with at least one of the plurality of user interface elements, while default GUI presentation data may include data describing a predefined presentation of the plurality of user interface elements.

In still another example, the GUI adjusting module is configured to adjust the presentation of at least one of the plurality of user interface elements by performing at least one of the following: (i) adjusting an arrangement of the plurality of user interface elements within the GUI; (ii) adjusting a size of at least one of the plurality of user interface elements within the GUI; (iii) adjusting a color of at least one of the plurality of user interface elements within the GUI; (iv) adjusting an amount of the plurality of user interface elements within the GUI; and/or (v) adjusting the content of at least one of the plurality of user interface elements within the GUI.

According to another embodiment of the instant disclosure, a computer program product embodied in a non-transitory computer-readable medium having an algorithm adapted to effectuate a method is provided. According to the method, external stimulus data may be obtained. The external stimulus data may be analyzed to detect a presence of a GUI presentation adjustment condition. In response to detecting the presence of the GUI presentation adjustment condition, GUI presentation adjustment condition data may be generated. Finally, the presentation of at least one of the plurality of user interface elements may be adjusted based on the GUI presentation adjustment condition data.

These and other objects, features, and advantages of the foregoing method, computing device, and computer program product will become more apparent upon reading the following specification in conjunction with the accompanying drawing figures.

### BRIEF DESCRIPTION OF THE FIGURES

Reference will now be made to the accompanying figures and flow diagrams, which are not necessarily drawn to scale, and wherein:

FIG. 1 is a block diagram illustrating one example of a computing device suitable for use in adjusting a graphical user interface in accordance with the disclosed technology.

FIG. 2 is a block diagram illustrating another example of a computing device suitable for use in adjusting a graphical user interface in accordance with the disclosed technology.

FIG. 3 is a block diagram illustrating one example of how the presentation of one or more user interface elements may be adjusted in accordance with the disclosed technology.

FIG. 4 is a flow diagram illustrating one example of a method for adjusting a graphical user interface in accordance with the disclosed technology.

### DETAILED DESCRIPTION

To facilitate an understanding of the principals and features of the disclosed technology, illustrative embodiments are explained below. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

Various embodiments of the disclosed technology provide methods, devices, and computer program products for adjusting a graphical user interface (GUI) including a plurality of user interface elements. In one example embodiment, a method for adjusting a GUI including a plurality of user interface elements is provided. The method may include obtaining external stimulus data. External stimulus data may include data associated with at least one user interface element of the plurality of user interface elements. The external stimulus data may be analyzed to detect a presence of a GUI presentation adjustment condition. In response to detecting the presence of a GUI presentation adjustment condition, GUI presentation adjustment condition data may be generated. The GUI presentation adjustment condition data may include data describing the GUI presentation adjustment condition. The presentation of at least one of the plurality of user interface elements may be adjusted based on the GUI presentation adjustment condition data.

In another example embodiment, a computer program product embodied in a non-transitory computer-readable medium comprising an algorithm adapted to effectuate a method is provided. The method may include obtaining external stimulus data. External stimulus data may include data associated with at least one user interface element of the plurality of user interface elements. The external stimulus data may be analyzed to detect a presence of a GUI presentation adjustment condition. In response to detecting the presence of a GUI presentation adjustment condition, GUI presentation adjustment condition data may be generated. The GUI presentation adjustment condition data may include data describing the GUI presentation adjustment condition. The presentation of at least one of the plurality of user interface elements may be adjusted based on the GUI presentation adjustment condition data.

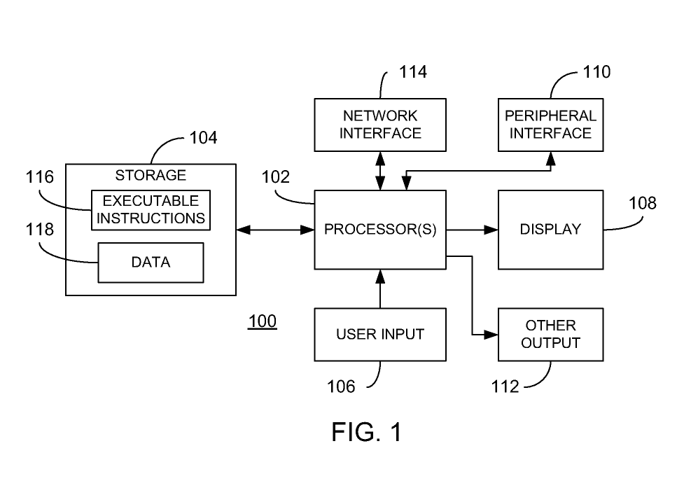

Referring now to the Figures, in which like reference numerals represent like parts, various embodiments of the computing devices and methods will be disclosed in detail. FIG. 1 is a block diagram illustrating one example of a computing device 100 suitable for use in adjusting a GUI including a plurality of user interface elements.

FIG. 1 illustrates a representative computing device 100 that may be used to implement the teachings of the instant disclosure. The device 100 may be used to implement, for example, one or more components of the computing device 200, as described in greater detail below. Regardless, the device 100 includes one or more processors 102 operatively connected to a storage component 104. The storage component 104, in turn, includes stored executable instructions 116 and data 118. In an embodiment, the processor(s) 102 may include one or more of a microprocessor, microcontroller, digital signal processor, co-processor or the like or combinations thereof capable of executing the stored instructions 116 and operating upon the stored data 118. Likewise, the storage component 104 may include one or more devices such as volatile or nonvolatile memory including but not limited to random access memory (RAM) or read only memory (ROM). Further still, the storage component 104 may be embodied in a variety of forms, such as a hard drive, optical disc drive, floppy disc drive, flash memory, etc. Processor and storage arrangements of the types illustrated in FIG. 1 are well known to those having ordinary skill in the art. In one embodiment, the processing techniques described herein are implemented as a combination of executable instructions and data within the storage component 104.

As shown, the computing device 100 may include one or more user input devices 106, a display 108, a peripheral interface 110, other output devices 112, and a network interface 114 in communication with the processor(s) 102. The user input device 106 may include any mechanism for providing user input to the processor(s) 102. For example, the user input device 106 may include a keyboard, a mouse, a touch screen, microphone and suitable voice recognition application, or any other means whereby a user of the device 100 may provide input data to the processor(s) 102. The display 108 may include any conventional display mechanism such as a cathode ray tube (CRT), flat panel display, or any other display mechanism known to those having ordinary skill in the art. In an embodiment, the display 108, in conjunction with suitable stored instructions 116, may be used to implement a graphical user interface. Implementation of a graphical user interface in this manner is well known to those having ordinary skill in the art. The peripheral interface 110 may include the hardware, firmware and/or software necessary for communication with various peripheral devices, such as media drives (e.g., magnetic disk or optical disk drives), other processing devices, or any other input source used in connection with the instant techniques. Likewise, the other output device(s) 112 may optionally include similar media drive mechanisms, other processing devices, or other output destinations capable of providing information to a user of the device 100, such as speakers, LEDs, tactile outputs, etc. Finally, the network interface 114 may include hardware, firmware, and/or software that allows the processor(s) 102 to communicate with other devices via wired or wireless networks, whether local or wide area, private or public, as known in the art. For example, such networks may include the World Wide Web or Internet, or private enterprise networks, as known in the art.

While the computing device 100 has been described as one form for implementing the techniques described herein, those having ordinary skill in the art will appreciate that other, functionally equivalent techniques may be employed. For example, as known in the art, some or all of the functionality implemented via executable instructions may also be implemented using firmware and/or hardware devices such as application specific integrated circuits (ASICs), programmable logic arrays, state machines, etc. Furthermore, other implementations of the device 100 may include a greater or lesser number of components than those illustrated. Once again, those of ordinary skill in the art will appreciate the wide number of variations that may be used is this manner. Further still, although a single computing device 100 is illustrated in FIG. 1, it is understood that a combination of such computing devices may be configured to operate in conjunction (for example, using known networking techniques) to implement the teachings of the instant disclosure.

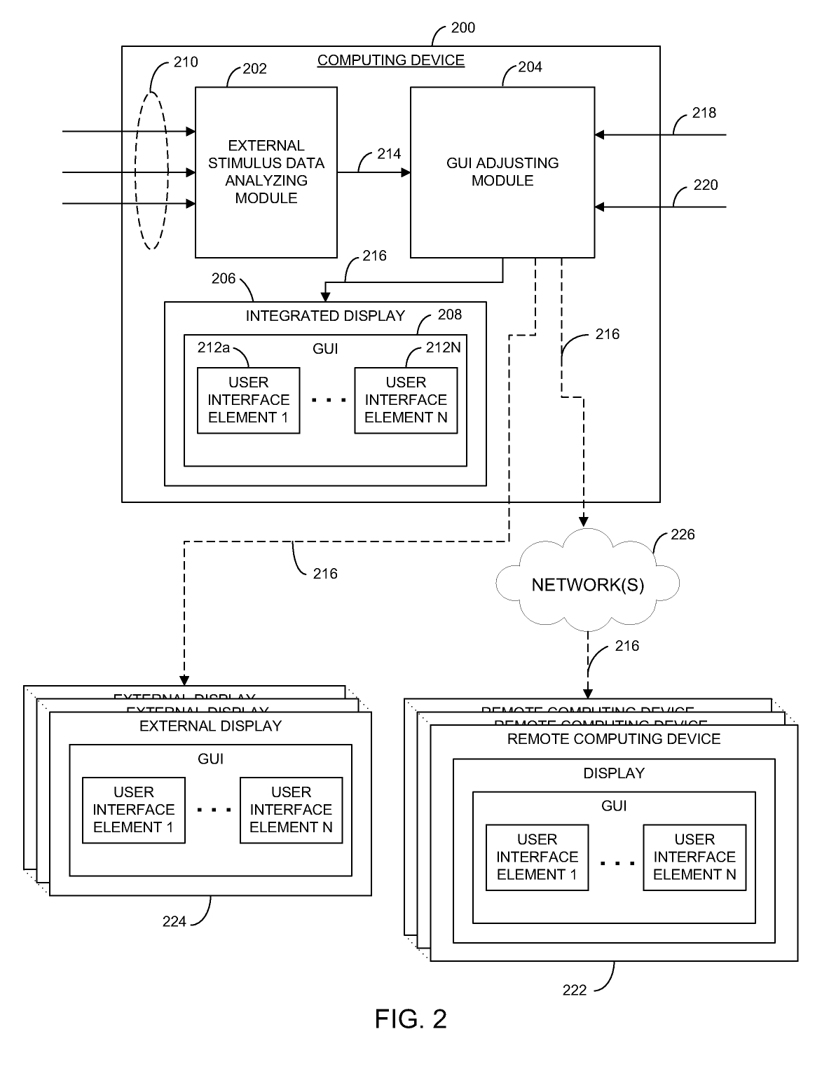

FIG. 2 is a block diagram illustrating another example of a computing device 200 for implementing the teachings of the disclosed technology. While the computing device 200 is discussed generically as to its functionality, it is noted that the computing device 200 may be implemented physically as the computing device 100 previously discussed. The computing device 200 includes an external stimulus data analyzing module 202 operatively connected to a GUI adjusting module 204. In one example, components 202 and 204 may be implemented as software modules that may be executed, for example, by one or more processors, such as the one or more processors 102 discussed above with regard to FIG. 1. However, those having ordinary skill in the art will recognize that the components 202 and 204 may equally be implemented using firmware and/or hardware devices such as application specific integrated circuits (ASICs), programmable logic arrays, state machines, etc.

Additionally, in one embodiment, the computing device 200 may include an integrated display 206. The integrated display 206 may take any of the forms discussed above with regard to display 108 (or other forms known in the art) and may be configured to implement a graphical user interface 208 in conjunction with suitable stored instructions, such as suitable stored instructions 116 discussed above.

In operation, the external stimulus data analyzing module 202 is configured to obtain (e.g., fetch or receive) external stimulus data 210. The external stimulus data 210 may be obtained, for example, from a server computer (not shown) over one or more suitable networks (wired or wireless) using data transmission techniques known in the art. Of course, the external stimulus data 210 may be obtained from additional suitable sources equally well without affecting the functionality of the computing device 200. Regardless, the external stimulus data 210 includes data associated with one or more user interface elements, such as user interface elements 212a-212n implemented as part of the GUI 208. In one example, the external stimulus data 210 includes data streams associated with one or more applications (i.e., computer programs) capable of being executed on the computing device 200.

While the preceding example contemplates external stimulus data 210 including “real-time” data streams, in another example of the instant disclosure, the external stimulus data 210 includes previously obtained data stream information. Such previously obtained external stimulus data 210 may be retained in storage, such as storage 104, and analyzed at any suitable time after it is obtained. In this manner, the external stimulus data 210 may include “real-time” data streams and/or previously obtained data stream information.

By way of example and not limitation, in one embodiment, the GUI 208 may comprise a desktop interface (as described above) that includes two or more icons, represented by user interface elements 212a-212N. User interface element 1 212a may comprise an icon representing a weather reporting application and user interface element N 212n may comprise an icon representing a navigation/map application. In this example, the external stimulus data 210 may include data being sent to the respective weather reporting and navigation/map applications, such as data configured to update the functionality of these applications. In this manner, the external stimulus data 210 may be associated with one or more applications (e.g., the weather reporting application and navigation/map application). Furthermore, in this example where the user interface elements 212a-212N are implemented as display data representing one or more applications (e.g., icons on a desktop), the external stimulus data 210 may include respective data streams associated with each of the applications. Stated another way in the context of this example, the external stimulus data 210 may include a first data stream associated with the weather reporting application and a second data stream associated with the navigation/map application. As used herein, a data stream includes any information being transmitted to the computing device 200 for the purpose of affecting the functionality of one or more components (e.g., applications) represented by user interface elements (e.g., user interface elements 212a-212N) displayed as part of a GUI (e.g., GUI 208).

Additionally, in one embodiment, the external stimulus data 210 comprises data that is independent of user behavior. That is to say, in this example, the manner in which a user of the computing device interacts with the respective user interface elements (e.g., user interface elements 212a-212N) has no bearing on the external stimulus data 210 that is analyzed to determine whether to adjust a GUI, such as GUI 208. This stands in stark contrast to many existing technologies where any determination regarding adjusting a GUI is based, at least in part, on the manner in which a user interacts with a GUI (e.g., by monitoring usage behavior associated with respective user interface elements and removing those user interface elements that are rarely interacted with from the GUI).

Furthermore, in another embodiment, the external stimulus data 210 comprises data that is independent of an ambient user environment. Stated another way, in this example, the ambient environmental conditions (e.g., lighting conditions, noise conditions, seismographic conditions, etc.) in an area proximate to the computing device 200 have no bearing on the external stimulus data 210 that is analyzed to determine whether to adjust a GUI, such as GUI 208. This stands in stark contrast to many existing technologies where any determination regarding adjusting a GUI is based, at least in part, on ambient environmental conditions in an area proximate to the computing device.

Further still, while an above example discussed user interface elements 212a-212N implemented as display data representing one or more applications (e.g. icons), those having ordinary skill in the art will recognize that many additional types of user interface elements exist that may be suitably associated with external stimulus data 210 in the context of the instant disclosure. For example, one additional type of user interface element that may be associated with external stimulus data is a “widget.” A widget may comprise a small specialized GUI application that provides some visual information and/or easy access to frequently used functions such as clocks, calendars, news aggregators, calculators and desktop notes. Thus, in one example of the computing device 200, user interface element 1 212a may comprise a clock widget displayed as part of the GUI 208. In this example, the external stimulus data 210 associated with the clock widget may include update time/date information being supplied from an external source (e.g., a remote server computer).

Moreover, as used herein, an association between the external stimulus data 210 and at least one user interface element (e.g., user interface element(s) 212a, 212N) may either be direct or indirect. By way of example, a direct association could result where the user interface element is a weather reporting widget and the external stimulus data 210 is data describing the current weather in the vicinity of the computing device 200. Thus, in this example, the external stimulus data 210 is directly associated with the user interface element because it directly relates to the functionality of that user interface element. One example of an indirect association would be where the user interface element is (again) a weather reporting widget and the external stimulus data 210 is data describing the current location of the computing device 200. Thus, in this example, the external stimulus data 210 does not directly describe weather conditions, but rather, describes the location of the computing device 200. Accordingly, in this example, the location information may be characterized as being indirectly associated with the weather reporting widget.

Continuing with the operation of the computing device 200, the external stimulus data analyzing module 202 is also configured to analyze the external stimulus data 210 to detect a presence of a GUI presentation adjustment condition. Generally speaking, a GUI presentation adjustment condition comprises high-importance data included as part of the external stimulus data 210 that is so critical that it triggers adjustment of the GUI 208. In one example, the external stimulus data analyzing module 202 is programmed to detect one or more different types of GUI presentation adjustment conditions for each of the one or more user interface elements 212a-212N.

As one simple example of the foregoing concept, consider a situation where the external stimulus data analyzing module 202 is programmed to analyze a data stream associated with a user interface element (e.g., an icon) representing a weather reporting application to detect whether a severe storm warming has been issued in the vicinity of the computing device 200. In this example, the GUI presentation adjustment condition would be the data included as part of the external stimulus data 210 indicating that a severe storm warning has been issued. While the foregoing example focused on a situation where the GUI presentation adjustment condition was data indicating the issuance of a severe storm warning, those having ordinary skill in the art will recognize that there may be many different GUI presentation adjustment conditions for any single user interface element, and many different GUI presentation adjustment conditions across the different types of user interface elements. That is to say, each specific GUI presentation adjustment condition is context-dependent upon the underlying user interface elements.

Continuing, the external stimulus data analyzing module 202 monitors and analyzes the external stimulus data 210 to detect the presence of a GUI presentation adjustment condition as described above. In the event that the external stimulus data analyzing module 202 does detect the presence of a GUI presentation adjustment condition, it is further configured to generate GUI presentation adjustment condition data 214. The GUI presentation adjustment condition data 214 comprises data describing the GUI presentation adjustment condition itself. Thus, continuing with the example above where the GUI presentation adjustment condition comprised data indicating the issuance of a severe weather warning, the GUI presentation adjustment condition data 214 could describe any and/or all pertinent information surrounding the severe weather warning. For example, this could include data 214 indicating the date(s) and/or time(s) that the severe weather warning is in effect, the geographic area(s) affected by the severe weather warning, the nature of the severe weather warning (e.g., whether the warning relates to a blizzard, thunderstorm, hurricane, etc.), etc. Again, the specific types of information that may be included as part of the GUI presentation adjustment condition data 214 are dependent upon the specific types of user interface elements 212a-212N being displayed as part of the GUI 208 and are not limited to the exemplary types of information discussed above.

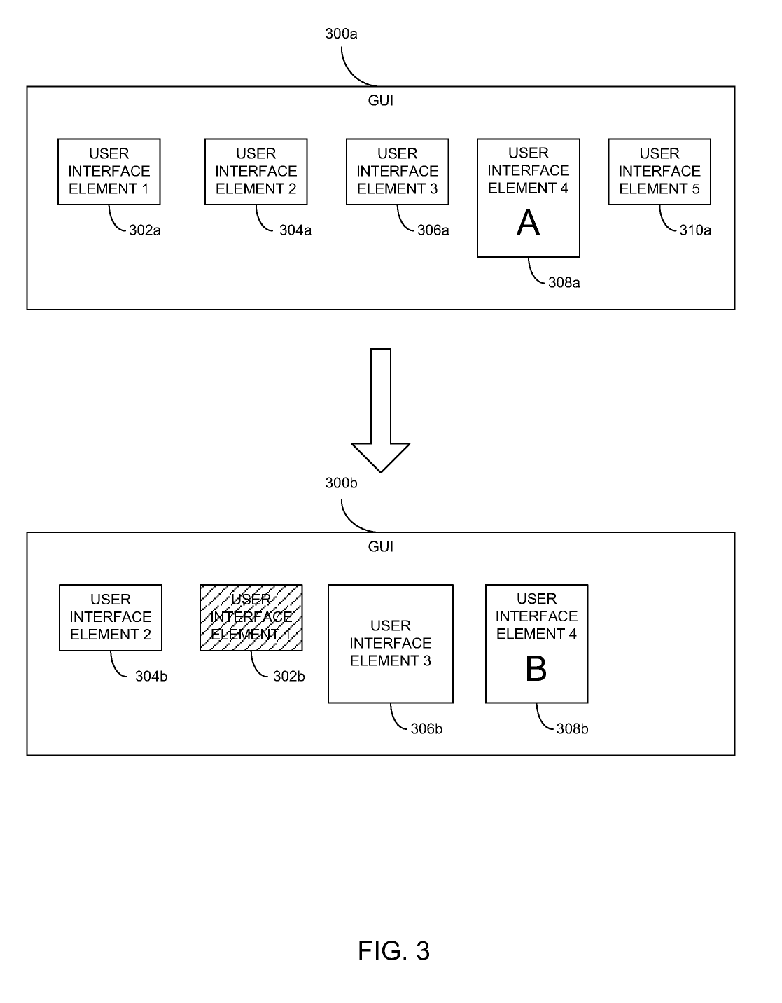

Upon receiving the GUI presentation adjustment condition data 214, the GUI adjusting module 204 is configured to adjust the presentation of at least one of the plurality of user interface elements 212a-212N displayed as part of the GUI 208 based on the GUI presentation adjustment condition data 214. Specifically, the GUI adjusting module 204 is configured to generate GUI adjusting data 216 configured to adjust the presentation of the GUI 208 in a variety of ways. Several of the exemplary ways in which the GUI adjusting module 204 may adjust the presentation of the GUI 208 are illustrated with regard to FIG. 3.

Turning briefly to FIG. 3, a GUI 300a having a first state (i.e., in an initial state prior to being adjusted) is shown at the top of this figure and the same GUI 300b having a second state (i.e., after being adjusted) is shown at the bottom of this figure. As shown, GUI 300a includes (in this example) three user interface elements 302a, 304a, and 306a that may take the form of any suitable user interface elements known in the art. GUI 300b illustrates the same GUI 300a described above, except that GUI 300b has been adjusted in line with the techniques described above.

Namely, the presentation of the plurality of the user interface elements has changed from a first state (shown as GUI 300a) to a second state (shown as GUI 300b). Thus, whereas user interface element 1 302a was initially located on the left side of GUI 300a, after the adjustment, it is located second from the left (as user interface element 302b). Furthermore, the size of user interface element 3 (shown initially as component 306a) has changed as part of the GUI adjustment and following the change is larger in size (as shown by component 306b). Additionally, the color of user interface element 1 (shown initially as component 302a) has changed following the adjustment, as illustrated by the cross-hatching covering component 302b. Further still, the content of user interface element 4 has changed following the adjustment. Specifically, in the first state of the GUI 300a, the content (i.e., the visual composition) of user interface element 4 308a is represented by the letter “A.” In the second state of the GUI 300b, the content of user interface element 4 308b is represented by the letter “B.” Finally, the amount of user interface elements included as part of the GUI has been adjusted from GUI 300a to GUI 300b. Namely, user interface element 5 310a was included as part of GUI 300a, but is no longer included as part of GUI 300b (i.e., user interface element 5 310a was removed from the GUI as part of the adjustment). While the preceding example showed how a user interface element (e.g., user interface element 310a) may be removed as part of a GUI adjustment, the instant disclosure also contemplates adding additional, new user interface elements as well. Stated another way, the amount of user interface elements may be adjusted by either adding or removing user interface elements.

Although the preceding example limited the discussion to adjusting (i) the arrangement of the user interface elements, (ii) the size of at least one of the user interface elements, (iii) the color of at least one of the user interface elements, (iv) the content of at least one of the user interface elements, and (v) the amount of user interface elements, those having ordinary skill in the art will appreciate that the presentation of the user interface elements may be further adjusted using any additional techniques known in the art.

Returning to FIG. 2, the GUI adjusting module 204 is further configured to use additional inputs in determining how to adjust a GUI, such as GUI 208 (i.e., how to configure the GUI adjusting data 216). Specifically, in one example, the GUI adjusting module 204 is further configured to obtain historical use data 218 and default GUI presentation data 220, either of which may be used alone, in conjunction with one another, or in conjunction with the GUI presentation adjustment condition data 214 to adjust the presentation of at least one user interface element (e.g., user interface element 1 212a) of a GUI (e.g., GUI 208).

As used herein, the historical use data 218 includes data describing one or more previous user interactions with at least one user interface element. For example, the historical use data 218 may indicate that a user of the computing device 200 routinely interacts with a specific user interface element, such as user interface element 1 212a. Accordingly, in this example, the GUI adjusting module is configured to adjust the presentation of at least one GUI interface element based on this historical use data 218.

As used herein, the default GUI presentation data 220 includes data describing a predefined presentation of the plurality of user interface elements making up a GUI. The default GUI presentation data 220 may include data describing the predefined presentation of the plurality of user interface elements in terms of the arrangement of the elements, the size of the elements (collectively or individually), the color of the elements (collectively or individually), or any other suitable presentation characteristics known to those having skill in the art.

By way of example and not limitation, the default GUI presentation data 220 may indicate predefined (e.g., preferred) presentation of the user interface elements. In one example, the GUI adjusting module 204 is configured to only adjust the presentation of the user interface elements making up a GUI when the GUI presentation adjustment condition data 214 and/or the historical use data 218 (either alone, or in combination) override the default GUI presentation data 220, for example, through the use of weighting techniques known to those having skill in the art.

FIG. 2 also illustrates embodiments where the computing device 200 is in communication with one or more remote computing devices 222 and/or one or more external displays 224. Specifically, in one embodiment, computing device 200 may be in communication with one or more remote computing devices 222 via a wired or wireless network, such as the networks discussed above with regard to FIG. 1. Furthermore, the remote computing devices 222 may be implemented as any suitable computing devices known in the art, such as those discussed above with regard to FIG. 1. In this manner, the computing device 200 may transmit the GUI adjusting data 216 to these remote computing device(s), which may in turn adjust their GUI(s) accordingly using techniques in line with those described above.

Moreover, much of the foregoing discussion focused on adjusting a GUI 208 implemented as part of an integrated display 206. However, those having skill in the art will appreciate that the same processing techniques may be implemented on one or more GUIs implemented via one or more external displays 224. The external displays 224 may be connected to the computing device 200 wirelessly using any suitable wireless networking protocol (such as those described above with regard to FIG. 1), or via wired connection using suitable interfaces (e.g., a suitable bus) known in the art.

Accordingly, the computing device 200 is operative to adjust not only a local GUI (e.g., GUI 208), but also one or more GUIs located on one or more external displays 224 and/or remote computing devices 222.

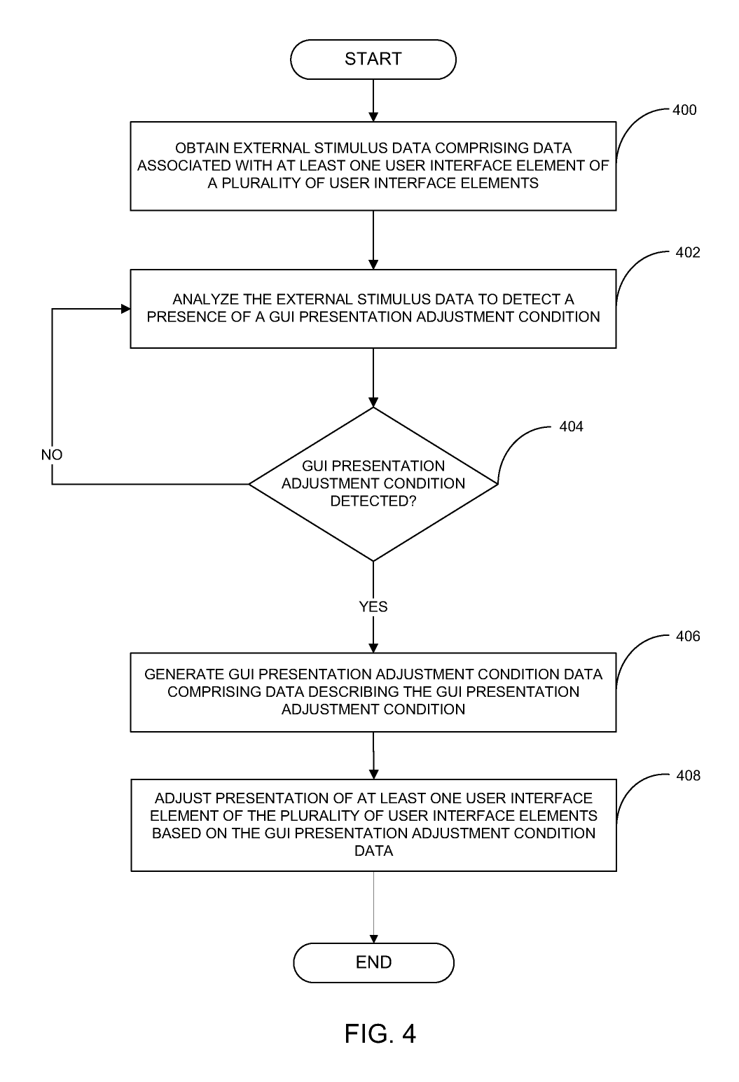

Referring now to FIG. 4, a flow diagram illustrating a method for adjusting a graphical user interface including a plurality of user interface elements is provided. While the computing devices 100, 200 are two forms for implementing the processing described herein (including that illustrated in FIG. 4), those having ordinary skill in the art will appreciate that other, functionally equivalent techniques may be employed. Furthermore, as known in the art, some or all of the functionalities implemented via executable instructions may also be implemented using firmware and/or hardware devices such as supplication specific circuits (ASICs), programmable logic arrays, state machines, etc. Once again, those of ordinary skill in the art will appreciate the wide number of variations that may be used in this manner.

Beginning at step 400, external stimulus data is obtained. Again, external stimulus data includes data associated with at least one user interface element of the plurality of user interface elements. At step 402, the external stimulus data is analyzed to detect a presence of a GUI presentation adjustment condition. At step 404, a determination is made as to whether a GUI presentation adjustment condition has been detected. If no GUI presentation adjustment condition has been detected, the method reverts back to step 402. However, in response to detecting a GUI presentation adjustment condition, the method proceeds to step 406. At step 406, GUI presentation adjustment condition data is generated. The GUI presentation adjustment condition data includes data describing the GUI presentation adjustment condition. Finally, at step 408, the presentation of at least one user interface element of the plurality of user interface elements is adjusted based on the GUI presentation adjustment condition data.

Certain embodiments of this technology are described above with reference to block and flow diagrams of computing devices and methods and/or computer program products according to example embodiments of the disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the disclosure.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments of this disclosure may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any devices or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer-implemented method for adjusting a graphical user interface (GUI) comprising a plurality of user interface elements, the method comprising:
obtaining, by a processing device, external stimulus data, wherein the external stimulus data comprises data associated with at least one user interface element of the plurality of user interface elements;
analyzing, by the processing device, the external stimulus data to detect a presence of a GUI presentation adjustment condition;
in response to detecting the presence of the GUI presentation adjustment condition, generating, by the processing device, GUI presentation adjustment condition data, wherein the GUI presentation adjustment condition data comprises data describing the GUI presentation adjustment condition; and
adjusting, by the processing device, presentation of at least one of the plurality of user interface elements based on the GUI presentation adjustment condition data.

2. The computer-implemented method of claim 1, wherein one or more of the plurality of user interface elements comprise display data representing one or more applications, and wherein analyzing the external stimulus data to detect the presence of the GUI presentation adjustment condition comprises analyzing respective data streams associated with each of the one or more applications.

3. The computer-implemented method of claim 1, wherein adjusting the presentation of at least one of the plurality of user interface elements is further based on at least one of the following:
historical use data comprising data describing one or more previous user interactions with at least one of the plurality of user interface elements; and
default GUI presentation data comprising data describing a predefined presentation of the plurality of user interface elements.

4. The computer-implemented method of claim 1, wherein adjusting the presentation of at least one of the plurality of user interface elements comprises at least one of the following:
adjusting an arrangement of the plurality of user interface elements within the GUI;
adjusting a size of at least one of the plurality of user interface elements within the GUI;
adjusting a color of at least one of the plurality of user interface elements within the GUI;
adjusting an amount of the plurality of user interface elements within the GUI; and
adjusting content of at least one of the plurality of user interface elements within the GUI.

5. The computer-implemented method of claim 1, wherein the external stimulus data comprises data independent of user behavior.

6. The computer-implemented method of claim 1, wherein the external stimulus data comprises data independent of an ambient user environment.

7. A computing device for adjusting a graphical user interface (GUI) comprising a plurality of user interface elements, the computing device comprising:
an external stimulus data analyzing module, wherein the external stimulus data analyzing module is configured to:
obtain external stimulus data comprising data associated with at least one user interface element of the plurality of user interface elements;
analyze the external stimulus data to detect a presence of a GUI presentation adjustment condition; and
in response to detecting the presence of the GUI presentation adjustment condition, generate GUI presentation adjustment condition data comprising data describing the GUI presentation adjustment condition; and
a GUI adjusting module operatively connected to the external stimulus data analyzing module, wherein the GUI adjustment module is configured to adjust presentation of at least one of the plurality of user interface elements based on the GUI presentation adjustment condition data.

8. The computing device of claim 7, wherein one or more of the plurality of user interface elements comprise display data representing one or more applications, and wherein the external stimulus data analyzing module is configured to detect the presence of the GUI presentation adjustment condition by analyzing respective data streams associated with each of the one or more applications.

9. The computing device of claim 7, wherein the GUI adjusting module is further configured to:
obtain (i) historical use data comprising data describing one or more previous user interactions with at least one of the plurality of user interface elements and (ii) default GUI presentation data comprising data describing a predefined presentation of the plurality of user interface elements; and
adjust the presentation of at least one user interface element of the plurality of user interface elements based on at least one of the historical use data and the default GUI presentation data.

10. The computing device of claim 7, wherein the GUI adjusting module is configured to adjust the presentation of at least one of the plurality of user interface elements by performing at least one of the following:
adjusting an arrangement of the plurality of user interface elements within the GUI;
adjusting a size of at least one of the plurality of user interface elements within the GUI; and
adjusting a color of at least one of the plurality of user interface elements within the GUI.

11. The computing device of claim 7, wherein the external stimulus data comprises data independent of user behavior.

12. The computing device of claim 7, wherein the external stimulus data comprises data independent of an ambient user environment.

13. A computer program product embodied in a non-transitory computer-readable medium, the computer program product comprising an algorithm adapted to effectuate a method comprising:
obtaining external stimulus data, wherein the external stimulus data comprises data associated with at least one user interface element of the plurality of user interface elements;
analyzing the external stimulus data to detect a presence of a GUI presentation adjustment condition;
in response to detecting the presence of the GUI presentation adjustment condition, generating GUI presentation adjustment condition data, wherein the GUI presentation adjustment condition data comprises data describing the GUI presentation adjustment condition; and
adjusting presentation of at least one of the plurality of user interface elements based on the GUI presentation adjustment condition data.

14. The computer program product of claim 13, wherein one or more of the plurality of user interface elements comprise display data representing one or more applications, and wherein analyzing the external stimulus data to detect the presence of the GUI presentation adjustment condition comprises analyzing respective data streams associated with each of the one or more applications.

15. The computer program product of claim 13, wherein adjusting the presentation of at least one of the plurality of user interface elements is further based on at least one of the following:
historical use data comprising data describing one or more previous user interactions with at least one of the plurality of user interface elements; and
default GUI presentation data comprising data describing a predefined presentation of the plurality of user interface elements.

16. The computer program product of claim 13, wherein adjusting the presentation of at least one of the plurality of user interface elements comprises at least one of the following:
adjusting an arrangement of the plurality of user interface elements within the GUI;
adjusting a size of at least one of the plurality of user interface elements within the GUI; and
adjusting a color of at least one of the plurality of user interface elements within the GUI;
adjusting an amount of the plurality of user interface elements within the GUI; and
adjusting content of at least one of the plurality of user interface elements within the GUI.

17. The computer program product of claim 13, wherein the external stimulus data comprises data independent of user behavior.

18. The computer program product of claim 13, wherein the external stimulus data comprises data independent of an ambient user environment.
